(19) United States
(12) Patent Application Publication
(10) Pub. No.: US 2012/0219684 A1
(43) Pub. Date: Aug. 30, 2012

(54) Bakeable Parchment Tray for Baking Pizza

(75) Inventors: Cathryn Fritz-Jung, Grosse Pointe Farms, MI (US); Hiba Kakish, Dearborn, MI (US); Jason E. Rebant, Holt, MI (US)

(73) Assignee: LITTLE CAESAR ENTERPRISES, INC., Detroit, MI (US)

(21) Appl. No.: 13/079,102

(22) Filed: Apr. 4, 2011

Related U.S. Application Data
(60) Provisional application No. 61/446,088, filed on Feb. 24, 2011.

(51) Int. Cl. B65D 81/34; A23P 1/00; B65D 1/34

(52) U.S. Cl. 426/394; 206/557; 426/523

(57) ABSTRACT

An apparatus is provided that may include a tray formed from parchment paper. The tray may include a bottom portion and at least one side portion extending upwardly from the bottom portion. The bottom portion may support a pizza while the pizza is baking. The pizza may be packaged and/or served to a consumer in the tray.

### CROSS-REFERENCE TO RELATED APPLICATIONS

This application claims the benefit and priority of 61/446,088, filed Feb. 24, 2011. The entire disclosure of the above application is incorporated herein by reference.

### FIELD

The present disclosure relates to a tray for a food item, and more particularly, to a bakeable parchment tray used for baking pizza.

### BACKGROUND

This section provides background information related to the present disclosure and is not necessarily prior art.

Businesses that make and sell pizzas and other food items to carryout and/or dine-in customers strive to reduce production and packaging costs while providing high-quality products to their customers. Materials, equipment and utensils used to produce and package the food items can have a significant impact on cost and/or quality of the end product.

### SUMMARY

This section provides a general summary of the disclosure, and is not a comprehensive disclosure of its full scope or all of its features.

The present disclosure provides an apparatus that may include a tray formed from parchment paper. The tray may include a bottom portion and at least one side portion extending upwardly from the bottom portion. The bottom portion may support a pizza while the pizza is baking.

In another form, the present disclosure provides a method that may include providing a tray formed from parchment paper. A pizza may be received in the tray and baked in the tray.

In yet another form, the present disclosure provides a method that may include receiving a food item in a tray formed from parchment paper. The food item may be baked in the tray. A packaging item may be attached to the tray while the food item is in the tray and after the food item has been baked in the tray. The packaging item, the tray and the food item may be provided to a consumer while the food item is in a condition for immediate consumption.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a pizza in a bakeable tray according to the principles of the present disclosure;

FIG. 2 is a cross-sectional view of the bakeable tray according to the principles of the present disclosure;

FIG. 3 is a cross-sectional view of another bakeable tray according to the principles of the present disclosure;

FIG. 4 is a perspective view of the bakeable tray and the pizza being supported by a carrying device according to the principles of the present disclosure;

FIG. 5 is a plan view of the tray and another carrying device in a first condition;

FIG. 6 is a perspective view of the tray and carrying device of FIG. 5 in a second condition; and

FIG. 7 is a perspective view of the tray and carrying device with an additional rigid cardboard insert.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

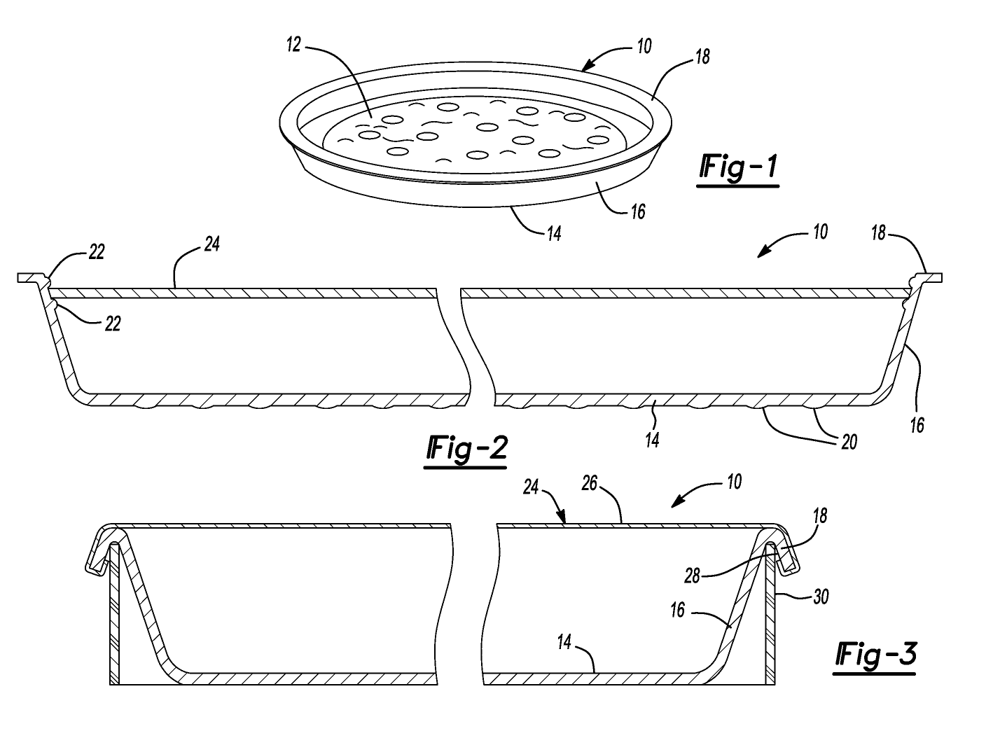

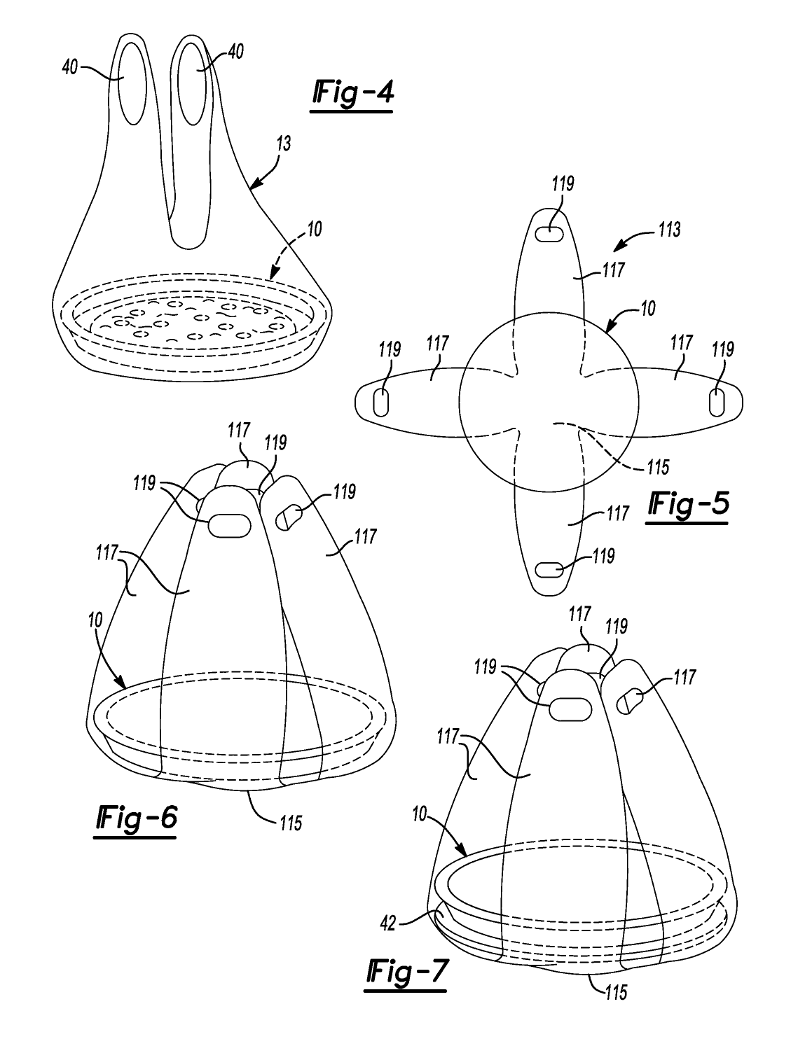

With reference to FIGS. 1-4, a bakeable pan or tray 10 is provided that may be used to bake and/or package one or more food items such as a pizza 12 and/or any other baked food item such as bread, a sandwich or a dessert. The pizza 12 and the tray 10 may be packaged for transportation in a carrying device 13 (FIG. 4). As will be subsequently described, the tray 10 may be configured such that a crust portion and a toppings portion of the pizza 12 have desirable properties as a result of baking and/or packaging the pizza 12 therein.

The tray 10 may include a base portion 14, a side portion 16, and a rim 18. The base portion 14 may be a generally flat and circular member and may support the pizza 12 during preparation, baking, storage and/or transportation of the pizza 12. The base portion 14 and/or the side portion 16 may include one or more ribs 20 providing rigidity and structural reinforcement for the tray 10. The ribs 20 can be generally linear or annular, for example. While the tray 10 is shown in the figures being generally circular in shape, in some configurations, the tray 10 may be polygonal or any other shape.

The side portion 16 may be integrally formed with the base portion 14. The side portion 16 may extend around a periphery of the base portion 14 and may extend generally upwardly therefrom. In some configurations, the side portion 16 may include one or more annular protrusions 22 extending radially inward therefrom. A lid 24 formed from cardboard, paper and/or plastic may be received between adjacent upper and lower protrusions 22. The lid 24 may cooperate with the side portion 16 to protect the pizza 12 from damage and to retain heat in the food item during storage and/or transportation of the food item. The lid 24 may be constructed to be substantially moisture impermeable to retain moisture on a toppings portion of the pizza 12. In some configurations, the lid 24 may include a paper or plastic film or a metallic foil 26 (FIG. 3) that may be adhered to and/or wrapped around the outer periphery of the rim 18, for example. The lid 24 may be rigid so as to provide reinforcement for the sidewalls 16 of the parchment paper tray 10. Alternatively, as a paper, plastic film, or metallic foil, the lid 24 can serve to hold the sidewalls from bending outward and therefore, provide a reinforcement for the parchment paper tray. The lid 24 and/or the film or foil 26 may be of the type disclosed in Assignee's commonly owed U.S. Patent Application Publication No. 2009/0071850, the disclosure of which is hereby incorporated by reference.

The rim 18 may extend radially outward from the side portion 16. In some configurations, the lid 24 may engage the rim 18 via a press or snap fit, for example. In some embodiments, the rim 18 may extend outwardly and downwardly, as shown in FIG. 3, and may cooperate with the side portion 16 to form an annular groove 28 having a generally U-shaped or V-shaped cross section. An annular reinforcement member 30 may surround the side portion 16 and engage the annular groove 28. The reinforcement member 30 may be formed from a substantially rigid cardboard or plastic, or other rigid material, and may provide structural rigidity for the tray 10 to support the pizza 12 during storage and/or transportation of the pizza 12 and tray 10.

The tray 10 may be formed from parchment paper having a basis weight of between 150-300 gsm, and a thickness of between about 0.007 inches (0.17 millimeters) and about 0.015 inches (0.381 millimeters). In one configuration, the parchment paper may be silicone parchment paper. The tray 10 can have a diameter of between 10 to 15 inches (25.4 and 38.1 centimeters), although other sizes can be utilized.

In some configurations, the tray 10 may be folded or otherwise formed from a flat sheet of parchment paper in a kitchen or preparation area of a restaurant or store shortly before baking the pizza 12, for example. The flat sheets can be scored to facilitate folding and/or may be otherwise marked to indicate where to fold and/or bend the parchment paper to form the tray 10. The flat sheets of parchment paper can be bought and stored in bulk rather than storing a large quantity of the trays 10 in their final shape and form. In this manner, the amount of space needed for shipping and storing the trays 10 can be reduced.

The parchment paper forming the tray 10 may be somewhat permeable to water-moisture while being substantially impermeable to fats and grease. In this manner, some water-moisture may soak through the tray 10 during baking of the pizza, but fats and grease from the pizza 12 may be restricted from soaking through the tray 10. Existing parchment paper used for baking exhibit these properties. The parchment paper may have sufficient thermal conductivity to allow moisture to be baked off of the crust of the pizza 12 and allow the crust to be browned as a result of the baking process. Unlike conventional metal baking pans, the tray 10 may have sufficiently low thermal conductivity to allow a person to touch the tray 10 shortly after removing the tray 10 and the pizza 12 from a hot oven, thus reducing the risk of burns. Furthermore, the parchment paper is sufficiently robust to allow the pizza 12 to be baked therein without significantly deteriorating the structural integrity of the tray 10. These properties allow the pizza 12 to be prepared, baked, cut, stored and packaged for sale and/or consumption in the tray 10.

The carrying device 13 may include a bag and/or a box, for example, and may receive the tray 10 and pizza 12 to facilitate transportation of the pizza 12. The carrying device 13 may be formed from plastic, paper and/or mesh, for example, and may include one or more handles 40 that a user may grasp to hold the carrying device 13, tray 10 and pizza 12. For larger sized pizzas, a rigid cardboard sheet 42 (FIG. 7) can be used under the tray 10 to provide added support for the tray 10 to be carried in the carrying device 13. The cardboard sheet 42 can have a diameter larger than or smaller than the tray 10.

With reference to FIGS. 5 and 6, another carrying device 113 is provided and may include a central portion 115 and a plurality of arms or support members 117 extending outwardly therefrom. The support members 117 may be movable relative to the central portion 115 between a storage position (FIG. 5) and a use position (FIG. 6). Each of the support members 117 may include an aperture 119 at or near a distal end thereof. The central portion 115 and the support members 117 may be formed from a polymeric material such as high-density polyethylene (HDPE), for example, and/or any other suitable polymeric, paper, or cardboard material. In some configurations, the central portion 115 and/or the support members 117 may be formed from a mesh material.

The carrying device 113 or multiple carrying devices 113 may be stored on a shelf or in a cabinet, for example, in the storage position prior to use. In the use position, the central portion 115 and the support members 117 may cooperate to support the tray 10 and the apertures 119 may cooperate to form a handle for the user to grasp while holding the carrying device 113. That is, the central portion 115 may engage the base portion 14 of the tray 10 and the support members 117 may engage the side portion 16, as shown in FIG. 6.

With reference to FIGS. 1-7, a method of preparing, baking, storing and transporting the pizza 12 will be described. As described above, a generally flat sheet of parchment paper may be folded and/or otherwise pre-formed into the shape of the tray 10 prior to use. Pizza dough may be placed in the tray 10 and sauce, cheese and/or other toppings may be applied to the dough. The tray 10 with the pizza 12 therein may be inserted into a heated oven for baking. The material properties of the tray 10 may allow the pizza 12 to be baked therein to achieve a desired temperature of the pizza 12 and a desired crispness of the crust and moisture of the toppings.

Upon baking the pizza 12 in the tray 10 for a predetermined time, the tray 10 and pizza 12 may be removed from the oven. In some embodiments, the reinforcement member 30 may be attached to the tray 10 after baking the pizza 12 to increase the rigidity of the tray 10. The pizza 12 may be cut into slices in the tray 10 using a pizza slicer, knife or other tool. The thickness and robustness of the material of the tray 10 may allow the tray to withstand this slicing operation without also being significantly cut by the slicing tool.

After the pizza 12 is sliced and/or otherwise prepared for consumption, the lid 24 may be wrapped onto or snapped into engagement with the rim 18 and/or the protrusions 22 in the side portion 16 of the tray 10. The pizza 12 may be stored in this condition on a warming rack or other suitable location until the pizza 12 is purchased and/or consumed. In this manner, a restaurant or store may bake one or more pizzas 12 and keep the pizzas 12 in a ready-to-eat condition in the tray 10 until one or more consumers arrive at the restaurant or store to purchase and/or consume the pizzas 12.

The tray 10 and pizza 12 may be placed in the carrying device 13, 113 to facilitate transportation of the tray 10 and pizza 12 out of the restaurant or store to a location where the pizza 12 will be subsequently consumed. In some embodiments, the reinforcement member 30 may be engaged with the tray 10 prior to placing the tray 10 in the carrying device 13, 113. It is anticipated that the reinforcement member can be used for stacking the prepared pizzas and may be reused in the restaurant. Alternatively, or additionally, a rigid cardboard sheet can be placed under the tray 10 to provide added support. In embodiments where the tray 10 and pizza 12 are packaged in the carrying device 113, the tray 10 may be placed on the central portion 115 of carrying device 113 while the carrying device 113 is in the storage position (FIG. 5). The support members 117 may then be wrapped upward around the side portion 16 of the tray 10 and radially inward over the tray 10 into the use position, as shown in FIG. 6. As described above, the apertures 119 can cooperate to form a handle for convenient transportation of the pizza 12, tray 10 and carrying device 113.

While the tray 10 is described above as being used for preparing, baking, storing, packaging and/or transporting the pizza 12, it will be appreciated that the tray 10 could be used for preparing, baking, storing, packaging and/or transporting any other food item including bread, calzones, sandwiches, and/or desserts, for example. Furthermore, it will be appreciated that the carrying devices 13, 113 could be configured in any other suitable manner. In some embodiments, the reinforcement member 30 could be integrally formed with the tray 10 or the carrying device 13, 113.

The bakeable parchment tray of the present disclosure allows for the elimination of metal pizza trays that require cleaning. Additionally, the tray replaces large conventional pizza boxes and other pizza packaging that create more waste than the parchment paper tray. The bakeable parchment paper tray therefore provides a less expensive and more environmentally beneficial packaging system.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An apparatus comprising:
a tray formed from parchment paper and including a bottom portion and a side portion extending upwardly from said bottom portion, said bottom portion supporting a pizza while said pizza is baking.

2. The apparatus of claim 1, wherein said tray includes a rim portion.

3. The apparatus of claim 1, wherein said side portion of said tray includes one or more protrusions and said apparatus further comprises a lid engaging said protrusions.

4. The apparatus of claim 1, wherein said bottom portion includes at least one rib structurally reinforcing said tray.

5. The apparatus of claim 1, wherein said tray is generally circular.

6. The apparatus of claim 1, further comprising a carrying device supporting said tray and said pizza.

7. The apparatus of claim 6, wherein said carrying device includes a plurality of arms extending around said side portion, said plurality of arms cooperating to form a handle supporting said tray and said pizza.

8. The apparatus of claim 6, wherein said carrying device includes a bag.

9. A method comprising:
providing a tray formed from parchment paper;
inserting a pizza in said tray; and
baking said pizza in said tray.

10. The method of claim 9, further comprising packaging said pizza and said tray after baking said pizza in said tray.

11. The method of claim 10, further comprising providing said pizza and said tray to an end user after packaging said pizza and said tray.

12. The method of claim 9, further comprising providing said pizza and said tray to an end user after baking said pizza in said tray.

13. The method of claim 9, further comprising providing said tray with a structural reinforcement feature.

14. The method of claim 13, wherein said structural reinforcement feature includes a rib.

15. The method of claim 13, wherein said structural reinforcement feature includes an annular member connected to said tray.

16. The method of claim 13, wherein said structural reinforcement feature includes a lid attached to said tray.

17. The method of claim 13, wherein said structural reinforcement feature includes a rigid cardboard sheet placed under said tray.

18. The method of claim 9, further comprising attaching a lid to said tray.

19. The method of claim 18, wherein said lid engages a rim on an outer periphery of said tray.

20. The method of claim 18, wherein said lid engages said tray via an interference fit.

21. The method of claim 9, further comprising inserting said tray and said pizza into a carrying device after baking said pizza, said carrying device including at least one handle supporting a weight of said tray, said pizza, and said carrying device.

22. The method of claim 9, further comprising forming said carrying device from a mesh material.

23. The method of claim 9, further comprising:
providing a flat sheet of material including a central portion and a plurality of arms extending outwardly from said central portion;
placing said tray on said central portion;
wrapping said plurality of arms around a portion of said tray; and
forming a handle from at least one of said plurality of arms.
